(19) United States
(12) Patent Application Publication
(10) Pub. No.: US 2023/0316268 A1
(43) Pub. Date: Oct. 5, 2023

(54) SYSTEMS AND METHODS FOR CROSS-PLATFORM CONVERSION AND EXCHANGE OF VIRTUAL ASSETS

(71) Applicant: JPMORGAN CHASE BANK, N.A., New York, NY (US)

(72) Inventors: Dave CAREY, Middletown, DE (US); Howard SPECTOR, Street, MD (US); Peter G. COSTANZO, Dublin, OH (US)

(21) Appl. No.: 18/189,846

(22) Filed: Mar. 24, 2023

Related U.S. Application Data
(60) Provisional application No. 63/362,440, filed on Apr. 4, 2022.

(51) Int. Cl. G06Q 20/38; G06Q 20/12; G06Q 30/0601; G06Q 40/04

(52) U.S. Cl. CPC G06Q 20/381; G06Q 20/123; G06Q 30/0643; G06Q 40/04

(57) ABSTRACT

Systems and methods for cross-platform conversion and exchange of virtual assets are disclosed. An exemplary method includes receiving, at an external application programming interface (API) gateway of a financial institution backend, an API call, including completed-objective data from an entertainment platform, wherein the completed-objective data represents an in-game objective completed by a user of the entertainment platform; processing, as input to a conversion engine, the completed objective data, wherein the conversion engine includes a conversion table, and wherein the conversion table includes conversion rates that specify a value of the in-game objective in a plurality of different assets; crediting the value of the in-game objective to an account of the user; and displaying, as output of the conversion engine, the value of the in-game objective in the plurality of different assets to the user in electronic form.

### BACKGROUND

### 1. Field of the Invention

The invention relates generally to systems and methods for cross-platform conversion and exchange of virtual assets.

### 2. Description of the Related Art

Entertainment systems and programs such as massively multiplayer online (MMO) games and various virtual and augmented reality platforms (that are sometimes referred to as a “metaverse”) seek to provide persistent virtual environments in which users can interact with other users. These virtual environments can include virtual economies where virtual assets and/or currencies can be obtained, bought, sold, traded, stored, etc. Current trends in such entertainment offerings seek to incorporate interoperability between platform providers for virtual assets. Currently, however, there are no means by which to exchange virtual assets obtained in one entertainment ecosystem for virtual assets that can be used in another entertainment ecosystem.

### SUMMARY

In some aspects, the techniques described herein relate to a method including: receiving, at an external application programming interface gateway of a financial institution backend, an application programming interface call, including completed-objective data from an entertainment platform, wherein the completed-objective data represents an in-game objective completed by a user of the entertainment platform; processing, as input to a conversion engine, the completed objective data, wherein the conversion engine includes a conversion table, and wherein the conversion table includes conversion rates that specify a value of the in-game objective in a plurality of different assets; crediting the value of the in-game objective to an account of the user; and displaying, as output of the conversion engine, the value of the in-game objective in the plurality of different assets to the user in electronic form.

In some aspects, the techniques described herein relate to a method, wherein the electronic form is a virtual branch of the financial institution, and wherein the virtual branch is graphically displayed in a virtual environment of the entertainment platform.

In some aspects, the techniques described herein relate to a method, wherein the electronic form is an account view of a webpage or an application of the financial institution.

In some aspects, the techniques described herein relate to a method, wherein the plurality of different assets includes one of a fiat currency, a crypto currency, a reward point currency of the financial institution, and an in-game currency of the entertainment platform.

In some aspects, the techniques described herein relate to a method, wherein the plurality of different currencies includes an in-game currency of a second entertainment platform.

In some aspects, the techniques described herein relate to a system including at least one computer including a processor, wherein the at least one computer is configured to: receive, at an external application programming interface gateway of a financial institution backend, an application programming interface call, including completed-objective data from an entertainment platform, wherein the completed-objective data represents an in-game objective completed by a user of the entertainment platform; process, as input to a conversion engine, the completed objective data, wherein the conversion engine includes a conversion table, and wherein the conversion table includes conversion rates that specify a value of the in-game objective in a plurality of different assets; credit the value of the in-game objective to an account of the user; and display, as output of the conversion engine, the value of the in-game objective in the plurality of different assets to the user in electronic form.

In some aspects, the techniques described herein relate to a system, wherein the electronic form is a virtual branch of the financial institution, and wherein the virtual branch is graphically displayed in a virtual environment of the entertainment platform.

In some aspects, the techniques described herein relate to a system, wherein the electronic form is an account view of a webpage or an application of the financial institution.

In some aspects, the techniques described herein relate to a system, wherein the plurality of different assets includes one of a fiat currency, a crypto currency, a reward point currency of the financial institution, and an in-game currency of the entertainment platform.

In some aspects, the techniques described herein relate to a system, wherein the plurality of different currencies includes an in-game currency of a second entertainment platform.

In some aspects, the techniques described herein relate to a non-transitory computer readable storage medium, including instructions stored thereon, which instructions, when read and executed by one or more computer processors, cause the one or more computer processors to perform steps including: receiving, at an external application programming interface gateway of a financial institution backend, an application programming interface call, including completed-objective data from an entertainment platform, wherein the completed-objective data represents an in-game objective completed by a user of the entertainment platform; processing, as input to a conversion engine, the completed objective data, wherein the conversion engine includes a conversion table, and wherein the conversion table includes conversion rates that specify a value of the in-game objective in a plurality of different assets; crediting the value of the in-game objective to an account of the user; and displaying, as output of the conversion engine, the value of the in-game objective in the plurality of different assets to the user in electronic form.

In some aspects, the techniques described herein relate to a non-transitory computer readable storage medium, wherein the electronic form is a virtual branch of the financial institution, and wherein the virtual branch is graphically displayed in a virtual environment of the entertainment platform.

In some aspects, the techniques described herein relate to a non-transitory computer readable storage medium, wherein the electronic form is an account view of a webpage or an application of the financial institution.

In some aspects, the techniques described herein relate to a non-transitory computer readable storage medium, wherein the plurality of different assets includes one of a fiat currency, a crypto currency, a reward point currency of the financial institution, and an in-game currency of the entertainment platform.

In some aspects, the techniques described herein relate to a non-transitory computer readable storage medium, wherein the plurality of different currencies includes an in-game currency of a second entertainment platform.

### BRIEF DESCRIPTION OF THE DRAWINGS

FIG. 1 is a block diagram of a system for providing cross-platform conversion and exchange of virtual assets, in accordance with aspects.

FIG. 2 is a logical flow for converting completed in-game objectives to various asset types, in accordance with aspects.

FIG. 3 is a block diagram of a computing device for implementing certain aspects of the present disclosure.

FIG. 4 is a logical flow for cross-platform conversion and exchange of virtual assets, in accordance with aspects.

### DETAILED DESCRIPTION OF EMBODIMENTS

The invention relates generally to systems and methods for cross-platform conversion and exchange of virtual assets.

Entertainment-focused organizations provide entertainment platforms that can host various entertainment software such as online games, and virtual and augmented reality environments. For any particular platform, there may be some level of fungibility of in-game assets across games provided by that platform. In-game assets, such as in-game currency, however, cannot be transacted in outside of the hosting platform. For example, in a metaverse, there can be a virtual economy, but the underlying transactional rails are specific to that metaverse. If there is a second metaverse provided via a second platform, conventional platform transactional systems will not be able to operate, complete transactions, or exchange assets across these platforms. Disclosed herein is technology for currency transfers and brokerage across entertainment platforms.

Entertainment platforms, as used herein, can include MMOs, other online game constructs, recreational virtual environments, virtual or augmented reality social environments, etc. In accordance with aspects, a virtual branch of a financial institution (a “virtual FI branch”) can be included in a persistent virtual environment provided by an entertainment platform provider. A virtual FI branch can be graphically represented in a virtual environment and can provide services where users can undertake transactions with respect to in-game assets and currencies.

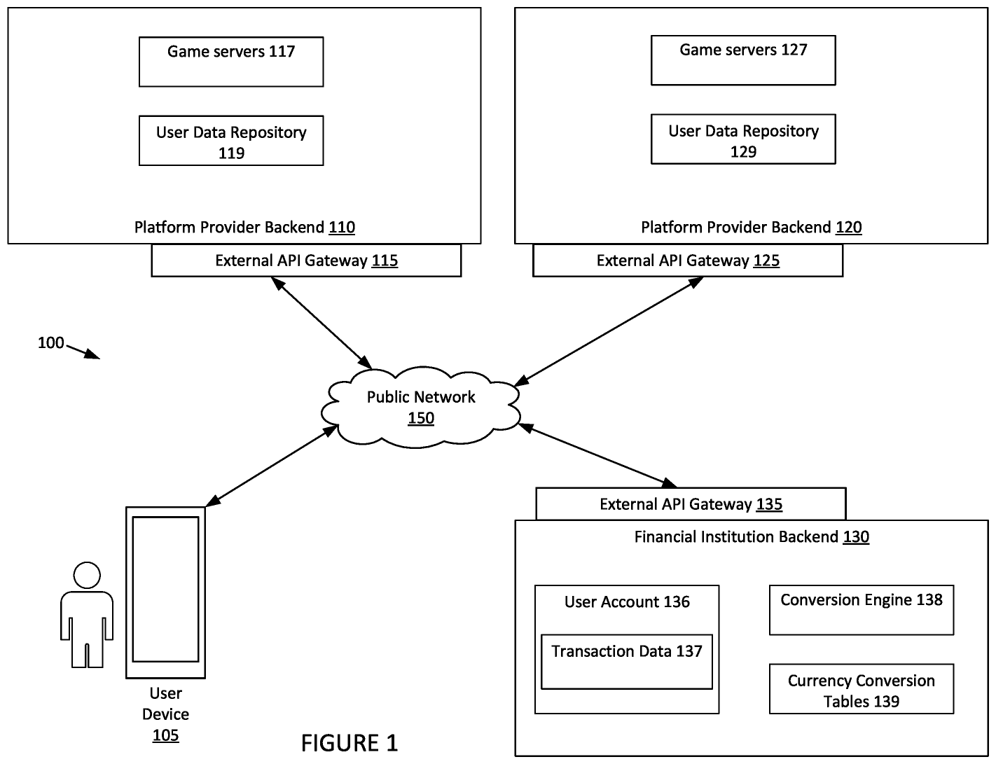

FIG. 1 is a block diagram of a system for providing cross-platform conversion and exchange of virtual assets, in accordance with aspects. System 100 includes user device 105, platform provider backend 110, platform provider backend 120 and financial institution backend 130. Each of the backend systems of FIG. 100 includes a respective external application programming interface (API) gateway. Platform provider backend 110 includes external API gateway 115, Platform provider backend 120 includes external API gateway 125, and financial institution backend 130 includes external API gateway 135. System 100 further includes public network 150.

User device 105 can be a smart phone, a tablet computer, a laptop computer, a desktop computer, or any electronic device that is capable of storing and executing frontend software components of an entertainment platform for the purposes of user engagement with the provided entertainment platform.

Platform provider backend 110 and platform provider backend 120 represent the backend technology infrastructures of different entertainment platform provider organizations. These technology infrastructures include game servers 117 and game servers 127 (respectively). Game servers can include various necessary and/or desirable application, web, and other servers configured to execute the provided entertainment environment and support the execution and usage thereof. Platform provider backend 110 and platform provider backend 120 can additionally include user data repository 119 and user data repository 129, respectively. These repositories can be configured to store user data such as user profiles, user personal information, etc.

Financial institution backend 130 represents the backend technology infrastructure of a financial institution. Financial institution backend 130 includes user account 136. User account 136 includes transaction data 137. Transaction data 137 can include a balance and a ledger that records debits and credits against the ledger. Transaction data 137 can also include an accounting of a balance in multiple different asset types, as further described herein. Financial institution backend 130 further includes conversion engine 138 and currency conversion tables 139. Conversion engine 138 can work in conjunction with currency conversion tables 139, as described herein, in order to show value balances of user account 136 in various asset types.

Generally, platform provider backend 110, platform provider backend 120, and financial institution backend 130 can include servers, computers, software applications, computer network mediums, and computer networking hardware and software for providing electronic services based on computer software applications executing on requisite hardware. Exemplary hardware and software include webservers, application servers, communication servers such as email servers and SMS servers, network routers, switches and firewalls, custom-developed software applications including hardware to execute the applications on, etc.

User device 105, platform provider backend 110, platform provider backend 120 and financial institution backend 130 can each be communicatively coupled to public network 150 with appropriate hardware and software. For instance, user device 105 can include a wired or wireless network interface card (NIC) that interfaces with public network 150 or an intermediary network and is configured with appropriate communication protocols. Likewise, platform provider backend 110, platform provider backend 120, and financial institution backend 130 can include hardware (NICs, switches, routers, etc.) configured with appropriate protocols for intercommunication with each other and with user device 105 over public network 150.

External API gateways 115, 125, and 135 can be partner APIs that require access rights from calling technology infrastructures in order for access to be provided. The external API gateways of system 100 can be accessible to partner organizations via public network 150. Public network 150 can represent any public network (e.g., the internet). The external API gateways of system 100 can be based on any suitable API architecture. Exemplary API architectures and/or protocols include SOAP (Simple Object Access Protocol), XML-RPC, REST (Representational State Transfer), or the like.

In accordance with aspects, systems described herein may provide one or more application programming interfaces (APIs) in order to facilitate communication with related/provided applications and/or among various public or partner technology backends, data centers, or the like. APIs may publish various methods and expose the methods via API gateways. A published API method may be called by an application that is authorized to access the published API methods. API methods may take data as one or more parameters of the called method. API access may be governed by an API gateway associated with a corresponding API. Incoming API method calls may be routed to an API gateway and the API gateway may forward the method calls to internal API servers that may execute the called method, perform processing on any data received as parameters of the called method, and send a return communication to the method caller via the API gateway. A return communication may also include data based on the called method and its data parameters. API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet).

Participation in virtual environments can include the completion of objectives. These objectives can be defined by the platform provider or other associated entities. Users can earn virtual assets, such as virtual currencies, through the completion of in-game objectives. Entertainment platforms can provide systems that track data related to in-game objectives. In-game objectives can be directed to maximizing participation time of the users. In-game objectives can also be structured to present interesting or relevant challenges to users. Examples of in-game objectives include thresholds for time spent participating, thresholds for time spent completing predefined tasks, thresholds for a number or frequency of logins to a platform, etc.

In accordance with aspects, in-game objectives can also be related to virtual FI branch engagement by users. Such objectives can incentivize platform users to engage with a virtual FI branch. Exemplary objectives include a threshold for branch visits (e.g., daily branch visits, or at least one visit per platform login, etc.).

In accordance with aspects, a financial institution represented virtually in an entertainment platform may also operate as a conventional financial institution in the physical realm and can also have physical branches. Services and products of the financial institution can be offered both in the physical and in the virtual branches. Services and products can include conventional services and products such as financial accounts (e.g., checking and savings accounts), loans, mortgages, etc. Offered services can also include services associated with the one or more virtual entertainment platforms. For example, as savings account for an in-game currency can be opened and a user's in-game currency can be deposited. Cross platform currency exchange services can also be offered.

In accordance with aspects, if a user of an entertainment platform is also a customer of one or more physical services provided by the financial institution, in-game objectives can be configured to provide incentive rewards that are associated with the financial institution. That is, instead of in-game currency or assets, an incentive reward can be an amount of reward currency (e.g., reward “points”) that the financial institution distributes for use of physical services (e.g., credit card usage). A user may be able to configure an associated user profile such that in-game assets earned while participating in the entertainment platform are denominated and received in one or more of the financial institution's provided reward currencies.

In other aspects, a platform user that is also a customer of the financial institution can opt to have earned rewards from the financial institution denominated and received in one or more in-game currencies. The earning of such financial institution rewards can be achieved through conventional means (e.g., applying for and/or using a credit card/account), or through completing in-game actions and objectives. For instance, an entertainment platform currency or a platform asset can be awarded to a user when the user takes certain actions or completes certain objectives inside a virtual FI branch. Exemplary actions/objectives include applying for an account or a loan, reviewing or exploring certain product descriptions, etc.

In accordance with aspects, a demand deposit account provided by a financial institution can be available to users of an entertainment platform at physical branch locations and at virtual branch locations. An entertainment platform user that is also a customer of a financial institution can open a deposit account with the financial institution and can fund the deposit account. Funding can be denominated in fiat currency, crypto currency, etc. In accordance with aspects, the user's account can be visible at a virtual branch in an entertainment platform.

When the user visits the virtual branch, balances of the account can be shown and available in an in-game currency and can be made available to purchase in-game assets. The financial institution can maintain one or more conversion rates in coordination with the entertainment platform provider. These rates can be stored and update in a conversion table. In accordance with aspects, if the user participates in more than one entertainment platform, the user's account balance can be shown at virtual branches in each platform and can reflect the native in-game currency for each respective platform. Separate conversion rates can be maintained for each platform.

Conversion tables can include conversions from an in-game currency to several other currency types. For instance, a user can convert in-game currency to fiat currency, to crypto currency, to a financial institution's proprietary reward point currency, to a standardized reward point currency, etc. In accordance with aspects, any of the aforementioned currencies can also be convertible to the in-game currency for which the table is structured for. In one aspect conversion tables for in-game currencies of disparate entertainment platforms can be related to facilitate a direct conversion from the in-game currency of one entertainment platform to the in-game currency of another in-game platform. This can be accomplished via an intermediate currency, such as a fiat currency (e.g., U.S. dollars), a crypto currency, etc.

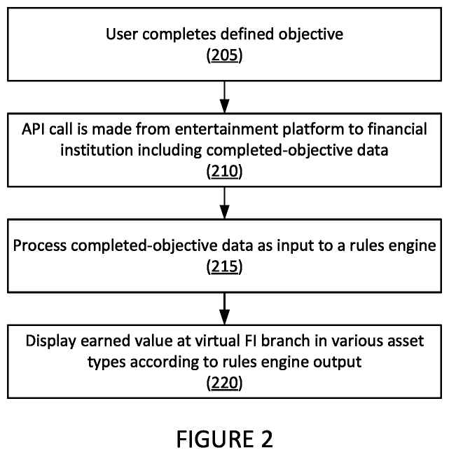

FIG. 2 is a logical flow for converting completed in-game objectives to various asset types, in accordance with aspects.

At step 205, a user participating in an entertainment platform can complete a defined object. The defined objective can be defined as an objective that carries a reward value. The reward value may be denominated in an in-game currency.

At step 210, the entertainment platform can make an API call to the backend of a financial institution. The financial institution may provide virtual branches within the entertainment platform. The API call can include parameterized data including the completed objective and the reward value denominated in the in-game currency of the entertainment platform.

At step 215, the financial institution backend can process the completed objective as input to a conversion engine. The conversion engine can include or be in operative communication with one or more conversion tables that store conversion rates for converting various currency types to various other currency types.

At step 220, a virtual branch can display the earned value of the completed objective as different currencies and/or assets (e.g., various in-game assets of offered by various entertainment platforms). For instance, a user engaging with an entertainment platform may view an account at a virtual FI branch provided in the entertainment platform. The account at the virtual FI branch can display a user's current balance in in-game currency. The account may offer the user the ability to select a different currency or asset to display the account balance in. Once selected, the account may show the account balance in the selected currency or asset.

For example, a default view of a user's account balance may be displayed as an in-game currency offered by the entertainment platform that the user is logged into. The user, however, may select to view the balance in other in-game assets, in a fiat or crypto currency, etc. Once selected, a conversion engine can utilize conversion tables to compute and display the value of the account balance in the selected currency/asset. Alternatively, an FI backend may execute conversions to various currencies/assets and display all currency/asset values in a virtual branch in a list format, so that a user can immediately see the account value in terms of units of various currencies/assets.

In accordance with aspects, the virtual FI branch can also keep a record of earned value so that the user can review value earned for different objectives. The record may be associated with the user's user account and be recorded as transaction data and/or as an earned transaction. Such a record can indicated the earned value in different currencies or assets.

In accordance with aspects, the techniques described herein can be utilized in any entertainment environment where a relevant financial institution provides in-game virtual branches and where the relevant financial institution maintains currency/asset conversion tables and operative API gateways and API methods for the relevant entertainment platform. In this way, a user of a first entertainment platform may earn in-game currency/assets in the first entertainment platform, may log into a second entertainment platform, and see the value of the in-game currency earned in the first platform reflected in a balance of an in-game currency or asset of the second platform.

In accordance with aspects, a user's account with an FI that maintains physical and virtual branches can be eligible for loans/mortgages made on virtual assets. Likewise, the user may be able to leverage physical assets for virtual assets through the FI account. For instance, a service may include an application and issuing process through which a user may be able to mortgage physical property to purchase virtual currency/assets in an entertainment platform.

Other aspects include modification of in-game asset tables (sometimes referred to as “loot” tables based on a user's defined preferences. That is, an currency/asset table can be defined that allows conversion of an in-game asset value to a different medium that the user prefers, such as a financial institution's reward point currency. This can be carried out through API calls to the FI backend and use of a conversion table and a conversion engine, as discussed herein.

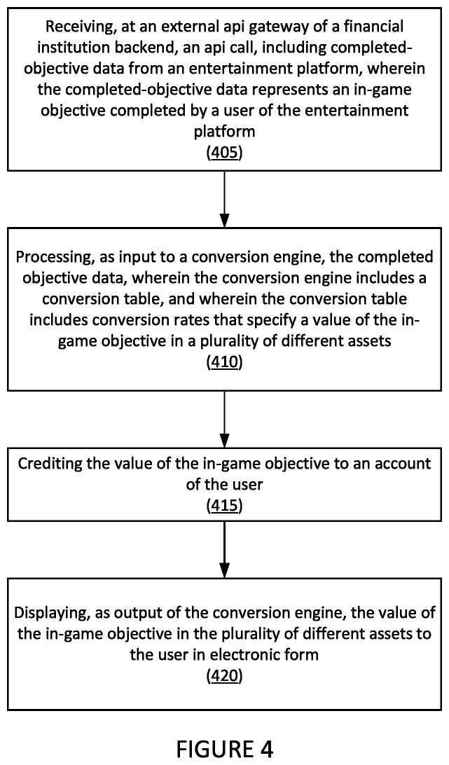

FIG. 4 is a logical flow for cross-platform conversion and exchange of virtual assets, in accordance with aspects.

At step 405, a logical flow may include receiving, at an external API gateway of a financial institution backend, an API call, including completed-objective data from an entertainment platform, wherein the completed-objective data represents an in-game objective completed by a user of the entertainment platform.

At step 410, a logical flow may include processing, as input to a conversion engine, the completed objective data, wherein the conversion engine includes a conversion table, and wherein the conversion table includes conversion rates that specify a value of the in-game objective in a plurality of different assets.

At step 415, a logical flow may include crediting the value of the in-game objective to an account of the user.

At step 420, a logical flow may include displaying, as output of the conversion engine, the value of the in-game objective in the plurality of different assets to the user in electronic form.

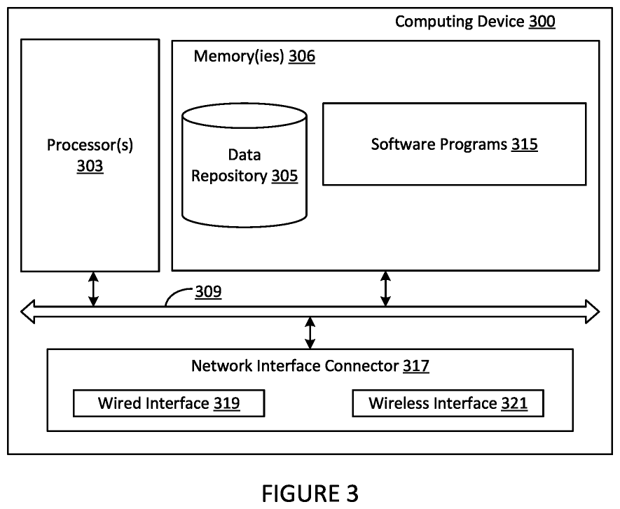

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such as a user device, game server, a conversion engine, conversion tables, API gateways, various database engines and database servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” etc. These may be a general-purpose computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized as a program, software program, or simply software. In one aspect, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, at an external application programming interface gateway of a financial institution backend, an application programming interface call, including completed-objective data from an entertainment platform, wherein the completed-objective data represents an in-game objective completed by a user of the entertainment platform;
processing, as input to a conversion engine, the completed objective data, wherein the conversion engine includes a conversion table, and wherein the conversion table includes conversion rates that specify a value of the in-game objective in a plurality of different assets;
crediting the value of the in-game objective to an account of the user; and
displaying, as output of the conversion engine, the value of the in-game objective in the plurality of different assets to the user in electronic form.

2. The method of claim 1, wherein the electronic form is a virtual branch of the financial institution, and wherein the virtual branch is graphically displayed in a virtual environment of the entertainment platform.

3. The method of claim 1, wherein the electronic form is an account view of a webpage or an application of the financial institution.

4. The method of claim 1, wherein the plurality of different assets includes one of a fiat currency, a crypto currency, a reward point currency of the financial institution, and an in-game currency of the entertainment platform.

5. The method of claim 4, wherein the plurality of different currencies includes an in-game currency of a second entertainment platform.

6. A system comprising at least one computer including a processor, wherein the at least one computer is configured to:
receive, at an external application programming interface gateway of a financial institution backend, an application programming interface call, including completed-objective data from an entertainment platform, wherein the completed-objective data represents an in-game objective completed by a user of the entertainment platform;
process, as input to a conversion engine, the completed objective data, wherein the conversion engine includes a conversion table, and wherein the conversion table includes conversion rates that specify a value of the in-game objective in a plurality of different assets;
credit the value of the in-game objective to an account of the user; and
display, as output of the conversion engine, the value of the in-game objective in the plurality of different assets to the user in electronic form.

7. The system of claim 6, wherein the electronic form is a virtual branch of the financial institution, and wherein the virtual branch is graphically displayed in a virtual environment of the entertainment platform.

8. The system of claim 6, wherein the electronic form is an account view of a webpage or an application of the financial institution.

9. The system of claim 6, wherein the plurality of different assets includes one of a fiat currency, a crypto currency, a reward point currency of the financial institution, and an in-game currency of the entertainment platform.

10. The system of claim 9, wherein the plurality of different currencies includes an in-game currency of a second entertainment platform.

11. A non-transitory computer readable storage medium, including instructions stored thereon, which instructions, when read and executed by one or more computer processors, cause the one or more computer processors to perform steps comprising:
receiving, at an external application programming interface gateway of a financial institution backend, an application programming interface call, including completed-objective data from an entertainment platform, wherein the completed-objective data represents an in-game objective completed by a user of the entertainment platform;
processing, as input to a conversion engine, the completed objective data, wherein the conversion engine includes a conversion table, and wherein the conversion table includes conversion rates that specify a value of the in-game objective in a plurality of different assets;
crediting the value of the in-game objective to an account of the user; and
displaying, as output of the conversion engine, the value of the in-game objective in the plurality of different assets to the user in electronic form.

12. The non-transitory computer readable storage medium of claim 11, wherein the electronic form is a virtual branch of the financial institution, and wherein the virtual branch is graphically displayed in a virtual environment of the entertainment platform.

13. The non-transitory computer readable storage medium of claim 11, wherein the electronic form is an account view of a webpage or an application of the financial institution.

14. The non-transitory computer readable storage medium of claim 11, wherein the plurality of different assets includes one of a fiat currency, a crypto currency, a reward point currency of the financial institution, and an in-game currency of the entertainment platform.

15. The non-transitory computer readable storage medium of claim 14, wherein the plurality of different currencies includes an in-game currency of a second entertainment platform.
